(19) United States
(12) Patent Application Publication
(10) Pub. No.: US 2023/0365095 A1
(43) Pub. Date: Nov. 16, 2023

(54) VEHICLE AIRBAG

(71) Applicant: HYUNDAI MOBIS CO., LTD., Seoul (KR)

(72) Inventor: Kyoung Won SEO, Yongin-si, Gyeonggi-do (KR)

(73) Assignee: HYUNDAI MOBIS CO., LTD., Seoul (KR)

(21) Appl. No.: 18/147,477

(22) Filed: Dec. 28, 2022

(30) Foreign Application Priority Data
May 10, 2022 (KR) 10-2022-0057268

(51) Int. Cl. B60R 21/232; B60R 21/2338; B60R 21/213

(52) U.S. Cl. CPC B60R 21/232; B60R 21/213; B60R 21/2338

(57) ABSTRACT

A vehicle airbag includes a main cushion that is unfolded from an upper side toward a seat of a vehicle due to a pressure of a gas and includes a first upper end part, a folding part extending downward from the first upper end part, and a first lower end part extending from the folding part toward the first upper end part, and positioned between the first upper end part and the folding part, and a shock absorption cushion including a second upper end part coupled to the first upper end part of the main cushion and a second lower end part coupled to the first lower end part of the main cushion.

### CROSS-REFERENCE TO RELATED APPLICATION

This application claims priority to and the benefit of Korean Patent Application No. 10-2022-0057268 filed on May 10, 2022, the disclosure of which is incorporated herein by reference in its entirety.

### BACKGROUND

### Field of the Invention

The present disclosure relates to a vehicle airbag, and more particularly, to a curtain airbag (CAB) device for protecting an occupant from a side of a vehicle in the event of a vehicle collision.

### Discussion of Related Art

In general, vehicles include various airbags such as driver airbags (DABs), passenger airbags (PABs), knee airbags (KABs), curtain airbags (CABs), and side airbags (SABs), to safely protect a driver and a passenger (hereinafter, simply referred to as an “occupant”) in the event of collision or overturning.

Among these airbags, the CAB is mounted on an upper side of a pillar and a roof rail or the ceiling or pillar of a vehicle, the CAB is fully unfolded from the top to the bottom in the event of vehicle collision or overturning to maintain a window curtain-like shape, and thus the occupant can be more reliably protected from ejection or injury through a window.

Since the airbags are certain units which can safely protect the occupant in the event of the vehicle collision or overturning, various ejection mitigation tests are conducted to reduce partial or complete ejection of the occupant through the window, and in some countries, regulations for the ejection mitigation tests are established, thereby increasing standards for improving stability of the vehicle.

Reinforcement of the regulations for the ejection mitigation tests inevitably acts as a factor that increase the size of an airbag cushion and the pressure of an inflator constituting the airbag, which increases the manufacturing cost of the airbag.

### SUMMARY OF THE INVENTION

The present disclosure is directed to providing a vehicle airbag capable of sufficiently protecting an occupant in the event of a vehicle collision or overturning while reducing likelihood of ejection of the occupant without greatly increasing manufacturing cost.

A vehicle airbag according to an embodiment of the present disclosure includes a main cushion that is unfolded from an upper side toward a seat of a vehicle due to a pressure of a gas and includes a first upper end part, a folding part extending downward from the first upper end part, and a first lower end part extending from the folding part toward the first upper end part, and positioned between the first upper end part and the folding part, and a shock absorption cushion including a second upper end part coupled to the first upper end part of the main cushion and a second lower end part coupled to the first lower end part of the main cushion.

The shock absorption cushion may be positioned between the main cushion and a vehicle body or between the main cushion and an occupant.

Each of a left width and a right width from a middle of the shock absorption cushion may be about 50 mm larger than a head form standard of an impactor determined by a regulation for an ejection mitigation test.

The vehicle airbag may further include an inflator that supplies the gas to the main cushion.

The vehicle airbag may further include a plurality of tab straps arranged along an edge of the first upper end part of the main cushion to maintain a roll folding state of the main cushion.

The vehicle airbag may further include a cushion tab that fixes an edge of the first upper end part of the main cushion and the plurality of tab straps to a vehicle body.

The vehicle airbag may further include a push pin that fixes the edge of the first upper end part of the main cushion to a vehicle body.

The vehicle airbag may further include a tether that fixes a tip end part of the main cushion to a vehicle body.

The vehicle airbag may further include a collision sensor that is disposed on a side surface of a vehicle body and generates and outputs a collision signal when a shock is applied to a vehicle.

The vehicle airbag may further include a controller that controls the inflator according to the collision signal of the collision sensor.

The controller may control the inflator so that the gas is supplied to the main cushion when the collision signal output from the collision sensor exceeds a predetermined reference value.

The main cushion may include a plurality of patterns, the gas may flow through at least one communication hole through which adjacent patterns among the plurality of patterns communicate with each other, and a boundary portion between the adjacent patterns may include a concave portion formed in a state in which the gas is injected.

Both end parts of the shock absorption cushion may be coupled to the adjacent patterns to cover the concave portion.

A vehicle airbag according to another embodiment of the present disclosure includes a main cushion that is unfolded by a gas supplied from an inflator and includes a plurality of patterns, at least one shock absorption cushion having both end parts coupled to adjacent patterns among the plurality of patterns to cover a boundary portion between the adjacent patterns, and a controller that controls the inflator according to a collision signal supplied from a collision sensor installed in a vehicle body to supply the gas to the main cushion.

The adjacent patterns may include at least one communication hole through which the gas flows.

The main cushion may include a first upper end part coupled to an upper side of the vehicle body, a folding part extending from the first upper end part and unfolded toward a seat, and a first lower end part extending from the folding part to the upper side of the vehicle body and disposed between the first upper end part and the folding part.

The shock absorption cushion may include a second upper end part, along with the first upper end part of the main cushion, coupled to the upper side of the vehicle body and a second lower end part coupled to the first lower end part of the main cushion.

The first and second upper end parts and the vehicle body may be coupled by a cushion tab, and the first lower end part and the second lower end part may be coupled by sewing.

The shock absorption cushion may be coupled to the main cushion to correspond to a position of an impact target determined by an ejection mitigation test.

The shock absorption cushion may be disposed between a B pillar and a C pillar of the vehicle body.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a cross-sectional view illustrating a vehicle airbag according to an embodiment of the present disclosure;

FIG. 2 is a cross-sectional view along line I-I′ of FIG. 1;

FIG. 3 is a view illustrating impact targets in vulnerable regions in which a vehicle occupant is likely to eject during an ejection mitigation test of the vehicle occupant; and

FIG. 4 is an explanatory view for describing collision effects of a vehicle airbag according to the related art and the vehicle airbag according to the present disclosure.

### DETAILED DESCRIPTION OF EXEMPLARY EMBODIMENTS

The present embodiments may be modified in other forms or various embodiments may be combined with each other, and the scope of the present disclosure is not limited to the following embodiments.

Even when a matter described in a specific embodiment is not described in another embodiment, it may be understood that the matter is related to another embodiment unless a description that is opposite or contradictory to the matter is made in the another embodiment.

For example, when a component A is described in a specific embodiment and a component B is described in another embodiment, even when an embodiment in which the component A and the component B are combined is not explicitly described, it may be understood that the embodiment belongs to the scope of the present disclosure unless a description opposite or contradictory thereto is made.

Terms such as first and second are used to describe various components. These terms are merely intended to distinguish one component from other components, and the terms do not limit the nature, order, or sequence of the components.

Terms used in the present application are used only to describe the specific embodiments and are not intended to limit the present disclosure. Singular expressions include plural expressions unless clearly otherwise indicated in the context. It should be understood in the present application that terms such as “include” or “have” are intended to indicate that features, numbers, steps, operations, components, parts, or combinations thereof described in the specification are present and do not exclude in advance the possibility of the presence or addition of one or more other features, numbers, steps, operations, components, parts, or combinations thereof.

Further, throughout the specification, a term “connection” may mean that two or more components are directly connected and as well as that two or more components are indirectly connected through another component, are physically connected, and electrically connected or that two components are integrated although the two components are referred to as different names according to positions or functions.

Hereinafter, embodiments of a vehicle airbag according to the present disclosure will be described in detail with reference to the accompanying drawings, and in description with reference to the accompanying drawings, the same or corresponding components are designated by the same reference numerals, and a duplicate description thereof will be omitted.

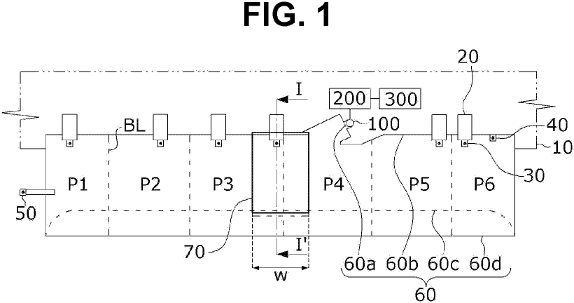

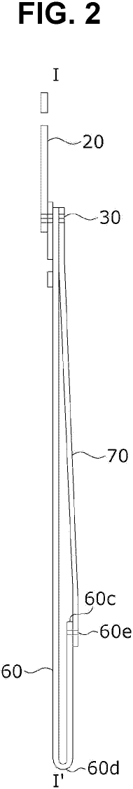

Hereinafter, a vehicle airbag according to an embodiment of the present disclosure will be described with reference to FIGS. 1 to 2.

FIG. 1 is a cross-sectional view illustrating a vehicle airbag according to an embodiment of the present disclosure, and FIG. 2 is a cross-sectional view along line I-I′ of FIG. 1.

Referring to FIGS. 1 and 2, the vehicle airbag according to the embodiment of the present disclosure may include a main cushion 60, a shock absorption cushion 70, an inflator 100, a controller 200, and a collision sensor 300.

The main cushion 60 is in a folded state, and when gas is injected into the main cushion 60 according to an impact applied to a vehicle, the main cushion 60 is inflated by the pressure of the gas, is unfolded from an upper side of the vehicle toward a lower seat in the vehicle, and thus can directly or indirectly protect an occupant from an external shock as well as prevent ejection of the occupant.

The main cushion 60 may include a gas inlet 60a through which gas is injected, a first upper end part 60b fixed to an upper portion of a vehicle body 10, a folding part 60d extending downward from the first upper end part 60b, a first lower end part 60c extending from the folding part 60d toward the first upper end part 60b and positioned between the first upper end part 60b and the folding part 60d, and a sewing part 60e coupled to the shock absorption cushion 70 which will be described below.

The main cushion 60 may include a plurality of cushion patterns P1 to P6 that may be partitioned by boundary portions BL. The plurality of cushion patterns P1 to P6 may be partitioned by a sewing method or the like. The adjacent cushion patterns (for example, P1 and P2, P2 and P3, P3 and P4, P4 and P5, and P5 and P6) of the main cushion 60 may be connected to each other through at least one communication hole so that the injected gas may flow therethrough.

In an example illustrated in FIG. 1, the plurality of cushion patterns P1 to P6 are arranged in a first direction (for example, a horizontal direction), but the present disclosure is not limited thereto. The plurality of cushion patterns P1 to P6 may be arranged in a second direction (a vertical direction, a diagonal direction, or the like) intersecting the first direction and may be arranged in the first direction and the second direction. Further, in the example illustrated in FIG. 1, the plurality of cushion patterns P1 to P6 are formed in a quadrangular shape, but may be formed in one of various shapes such as a circular shape, an elliptic shape, and a polygonal shape, or combinations thereof.

When the main cushion 60 includes the plurality of cushion patterns P1 to P6, even when the cushion patterns are torn by an external shock, additional damage to other cushion patterns can be prevented, and thus ejection of the occupant to the outside of a vehicle body and injury of the occupant due to the impact can be prevented.

The shock absorption cushion 70 may include a second upper end part coupled to the first upper end part 60b of the main cushion 60 and a second lower end part coupled to the first lower end part 60c of the main cushion 60. The shock absorption cushion 70 may also include first and second side end parts coupled to two adjacent cushion patterns (for example, P3 and P4 in FIG. 1).

The shock absorption cushion 70 may cover the boundary portion BL between the two adjacent cushion patterns P3 and P4. Since the boundary portion BL between the two adjacent cushion patterns P3 and P4 is formed by a sewing method or the like, a concave portion may be formed in a state in which gas is injected. Since the shock absorption cushion 70 supports, from both sides, the concave portion formed in the boundary portion BL between the two adjacent cushion patterns P3 and P4, the relatively thin concave portion can be prevented from being damaged in the event of the external shock, and thus the ejection of the occupant from the vehicle or injury of the occupant can be prevented.

The shock absorption cushion 70 may be disposed between the main cushion 60 and the vehicle body 10 or the main cushion 60 and the occupant.

Each of a left width and a right width from a middle of a width w of the shock absorption cushion 70 may be formed to be about 50 mm larger than a head form standard of an impactor determined by the regulations for the ejection mitigation test. A length or height of the shock absorption cushion 70 may vary according to a vehicle model.

The inflator 100 may be controlled by the controller 200 and generate gas according to a control signal of the controller 200 to supply the generated gas to the main cushion 60. The inflator 100 may supply gas to the main cushion 60 in a method in which a head is coupled to the main cushion 60.

The controller 200 may control the inflator 100 such that the inflator 100 supplies gas to the main cushion 60. For example, when a collision signal output from the collision sensor 300 exceeds a predetermined reference value, the controller 200 may control the inflator 100 to supply gas to the main cushion 60.

The collision sensor 300 may be disposed on a side surface of the vehicle body. When a collision accident occurs or a shock is applied to the vehicle body, when the shock is a predetermined value or more, the collision sensor 300 generates the collision signal to supply the collision signal to the controller 200.

The vehicle airbag according to the embodiment of the present disclosure may further include a plurality of tab straps 20, a plurality of cushion tabs 30, a push pin 40, and a tether 50.

The plurality of tab straps 20 may be arranged along an edge of the first upper end part 60b of the main cushion 60 to maintain a roll folding state of the main cushion 60. Each of the plurality of tab straps 20 may include one end part that is fixed to the vehicle body by the cushion tab 30 and the other end part that surrounds and temporarily maintains the folded main cushion 60 and releases the folded state of the main cushion 60 as illustrated in FIG. 1 when gas is injected into the main cushion 60 and the main cushion 60 is inflated.

The plurality of cushion tabs 30 may fix end parts of the plurality of tab straps 20 and the first upper end part 60b of the main cushion 60 to the vehicle body 10. The plurality of cushion tabs 30 may also fix the second upper end part of the shock absorption cushion 70 to the vehicle body 10 together with the end parts of the plurality of tab straps 20 and the first upper end part 60b of the main cushion 60. The plurality of cushion tabs 30 may be implemented using a fastening unit such as a bolt.

The push pin 40 may be disposed in a region, in which the tab straps 20 and the cushion tabs 30 are not arranged, to fix the main cushion 60 to the vehicle body 10. For example, the push pin 40 may be disposed near a corner region of the main cushion 60.

The tether 50 may provide rigidity to a tip end part of the main cushion 60 and fix the tip end part of the main cushion 60 to the vehicle body 10.

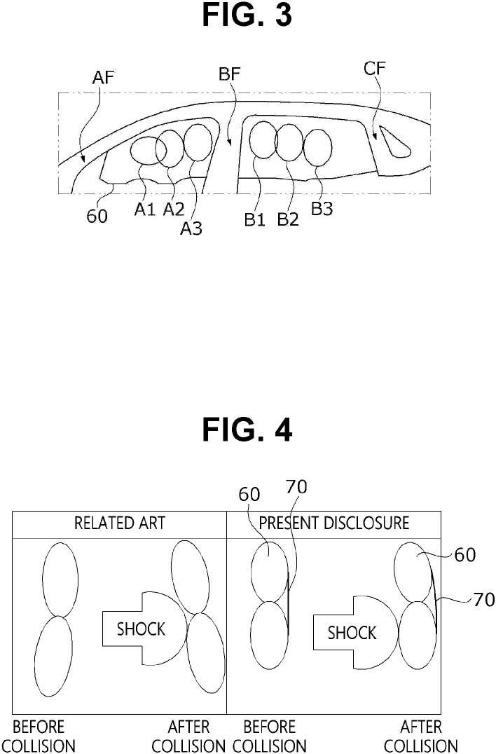

Next, installation and effects of the vehicle airbag according to the embodiment of the present disclosure will be described with reference to FIGS. 3 and 4.

FIG. 3 is a view illustrating a relationship between the airbag and impact targets in vulnerable regions in which a vehicle occupant is likely to eject during an ejection mitigation test of the vehicle occupant, and FIG. 4 is an explanatory view for conceptually describing collision effects of a vehicle airbag according to the related art and the vehicle airbag according to the present disclosure.

Referring to FIG. 3, the vehicle airbag according to the embodiment of the present disclosure is installed on a side surface between front and rear surfaces of a vehicle and is applied as a curtain airbag (CAB).

The main cushion 60 of the vehicle airbag according to the embodiment of the present disclosure may be disposed to correspond to a window between an A pillar AF and a B pillar BF of the vehicle and a window between the B pillar BF and a C pillar CF. In FIG. 3, regions A1, A2, and A3 between the A pillar AF and the B pillar BF and regions B1, B2, and B3 between the B pillar BF and the C pillar CF are ejection-vulnerable regions through which the occupant is easily ejected in the event of collision and indicate impact target regions hit by the impactor during the ejection mitigation test (EM test). These ejection-vulnerable regions are regions determined by a vehicle test and positions thereof may be changed according to a vehicle model.

In the embodiment of the present disclosure, an example in which the shock absorption cushion of the vehicle airbag according to the present disclosure is disposed in the region B2 between the B pillar BF and the C pillar CF, which is determined as an ejection-most vulnerable region in a specific vehicle model (Genesis G90 RS4), will be described.

In order to evaluate how much ejection mitigation is improved, after the vehicle airbag without the shock absorption cushion according to the related art and the vehicle airbag according to the embodiment of the present disclosure were applied to the Genesis G90 RS4, a test was performed according to an evaluation item TDP_W20TA001 Ejection Mitigation procedure of North American ejection mitigation regulations. In the EM evaluation, the amount of ejection was measured after an impact was applied to a head form of the impactor for 1.5 seconds in a direction perpendicular to the window of the region B2 between the B pillar BF and the C pillar CF at a speed of 20 km/h. In this case, the shock absorption cushion 70 of the vehicle airbag according to the embodiment of the present disclosure is formed such that each of a left width and a right width from a middle thereof is about 50 mm greater than the width of the head form.

As a result of the test, the EM evaluation of the vehicle airbag according to the related art and the vehicle airbag according to the embodiment of the present disclosure showed the amount of ejection as in [Table 1].

TABLE 1

| Item | | EM test result | |
|---|---|---|---|
| | | Impact target B2 (vertical direction) | |
| | | Related art | Present disclosure |
| EM evaluation | 20 km/h (1.5 seconds) | 94.0 mm ejection | 56.2 mm ejection |

As can be seen from [Table 1], in the vehicle airbag according to the related art, the amount of ejection was 94.9 mm, which exceeds an 80 mm target in North American ejection mitigation regulations. However, in the vehicle airbag according to the present disclosure, the amount of ejection was merely 56.2 mm, which is much less than the 80 mm targeted in North American ejection mitigation regulations and is 37.8 mm less than the vehicle airbag according to the related art.

FIG. 4 is a conceptual view illustrating a state in which, when a shock is applied to the vehicle airbag according to the related art and the vehicle airbag according to the embodiment of the present disclosure, the occupant collides with the airbag by a reaction and thus the shock is applied to the airbag. In the case of the airbag according to the embodiment of the present disclosure, it can be seen why the shock applied to the main cushion 60 is dispersed by the shock absorption cushion 70, and thus the amount of ejection from the window of the vehicle is reduced.

Thus, the vehicle airbag according to the embodiment of the present disclosure can sufficiently prevent ejection and injury of the vehicle occupant due to vehicle collision or external shock.

According to the vehicle airbag according to the embodiment of the present disclosure, a portion or the entirety of the body of an occupant is prevented from being ejected through a side window in the event of vehicle collision and overturning or impact, and thus occupant protection performance can be improved.

Further, according to the embodiment of the present disclosure, performance evaluation suitable for a vehicle airbag performance test standard can be performed.

Although the specific embodiments of the present disclosure have been described above, those skilled in the art may understand that the present disclosure may be variously modified and changed without departing from the spirit and scope of the present disclosure described in the appended claims.

What is claimed is:

1. A vehicle airbag comprising:
a main cushion adapted to be unfolded from an upper side of a vehicle toward a seat in the vehicle due to a pressure of a gas and comprises a first upper end part, a folding part extending downward from the first upper end part, and a first lower end part extending from the folding part toward the first upper end part, and positioned between the first upper end part and the folding part; and
a shock absorption cushion comprises a second upper end part coupled to the first upper end part of the main cushion and a second lower end part coupled to the first lower end part of the main cushion, wherein:
the main cushion comprises a plurality of patterns, the gas flows through at least one communication hole through which adjacent patterns among the plurality of patterns communicate with each other, and
a boundary portion between the adjacent patterns comprises a concave portion formed in a state in which the gas is injected and both end parts of the shock absorption cushion are coupled to the adjacent patterns to cover the concave portion.

2. The vehicle airbag of claim 1, wherein the shock absorption cushion is positioned between the main cushion and a vehicle body or between the main cushion and an occupant.

3. The vehicle airbag of claim 2, wherein each of a left width and a right width from a middle of the shock absorption cushion is about 50 mm larger than a head form standard of an impactor determined by a regulation for an ejection mitigation test.

4. The vehicle airbag of claim 1, further comprising an inflator adapted to supply the gas to the main cushion.

5. The vehicle airbag of claim 1, further comprising a plurality of tab straps arranged along an edge of the first upper end part of the main cushion adapted to maintain a roll folding state of the main cushion.

6. The vehicle airbag of claim 5, further comprising a cushion tab adapted to fix the edge of the first upper end part of the main cushion and the plurality of tab straps to a vehicle body.

7. The vehicle airbag of claim 1, further comprising a push pin adapted to fix an edge of the first upper end part of the main cushion to a vehicle body.

8. The vehicle airbag of claim 1, further comprising a tether adapted to fix a tip end part of the main cushion to a vehicle body.

9. The vehicle airbag of claim 4, further comprising a collision sensor disposed on a side surface of a vehicle body and adapted to generate and output a collision signal when a shock is applied to the vehicle.

10. The vehicle airbag of claim 9, further comprising a controller adapted to control the inflator according to the collision signal of the collision sensor.

11. The vehicle airbag of claim 10, wherein the controller is adapted to control the inflator so that the gas is supplied to the main cushion when the collision signal output from the collision sensor exceeds a predetermined reference value.

12. (canceled)

13. (canceled)

14. A vehicle airbag comprising:
a main cushion adapted to be unfolded by a gas supplied from an inflator and comprising a plurality of patterns;
at least one shock absorption cushion having a first upper end part and a first lower end part, both end parts coupled to adjacent patterns among the plurality of patterns to cover a boundary portion between the adjacent patterns; and
a controller adapted to control the inflator according to a collision signal supplied from a collision sensor installed in a vehicle body to supply the gas to the main cushion, wherein:
the main cushion comprises a plurality of patterns, the gas flows through at least one communication hole through which adjacent patterns among the plurality of patterns communicate with each other, and
a boundary portion between the adjacent patterns comprises a concave portion formed in a state in which the gas is injected and both end parts of the shock absorption cushion are coupled to the adjacent patterns to cover the concave portion.

15. The vehicle airbag of claim 14, wherein the adjacent patterns comprise at least one communication hole through which the gas flows.

16. The vehicle airbag of claim 14, wherein:
the first upper end part is coupled to an upper side of the vehicle body;
a folding part extending from the first upper end part and adapted to unfold toward a seat; and
the first lower end part extends from the folding part to the upper side of the vehicle body and disposed between the first upper end part and the folding part.

17. The vehicle airbag of claim 16, wherein the shock absorption cushion includes a second upper end part, along with the first upper end part of the main cushion, coupled to the upper side of the vehicle body and a second lower end part coupled to the first lower end part of the main cushion.

18. The vehicle airbag of claim 17, wherein the first and second upper end parts and the vehicle body are coupled by a cushion tab, and the first lower end part and the second lower end part are coupled by sewing.

19. The vehicle airbag of claim 14, wherein the shock absorption cushion is coupled to the main cushion to correspond to a position of an impact target determined by an ejection mitigation test.

20. The vehicle airbag of claim 14, wherein the shock absorption cushion is disposed between a B pillar and a C pillar of the vehicle body.

21. The vehicle airbag of claim 1, wherein the shock absorption cushion supports both sides of the concave portion along the boundary portion.

22. The vehicle airbag of claim 14, wherein the shock absorption cushion supports both sides of the concave portion along the boundary portion.
